(19) United States
(12) Patent Application Publication
(10) Pub. No.: US 2021/0278012 A1
(43) Pub. Date: Sep. 9, 2021

(54) FLUID DRIVE VALVE

(71) Applicant: FUJIKIN INCORPORATED, Osaka-shi (JP)

(72) Inventors: Taichi Kitano, Osaka-shi (JP); Tsuyoshi Tanikawa, Osaka-shi (JP)

(21) Appl. No.: 16/497,047

(22) PCT Filed: Jun. 22, 2018
(86) PCT No.: PCT/JP2018/023761

§ 371 Date: Sep. 24, 2019

(30) Foreign Application Priority Data
Jun. 30, 2017 (JP) 2017-129667

(51) Int. Cl. F16K 37/00; F16K 31/122

(52) U.S. Cl. CPC F16K 37/0041; F16K 31/122

(57) ABSTRACT

Provided is a fluid drive valve, which facilitates continuation of monitoring all the time, and which allows detection of leakage of an operation fluid from an actuator even when the actuator is operating. A pressure sensor is disposed on a pressure receiving surface, inside an actuator, on which pressure of an operation fluid acts. A pressure sensor is disposed on a non-pressure receiving surface, inside the actuator, on which pressure of the operation fluid does not act. In addition, a position sensor is disposed to detect the position of a valve stem.

### TECHNICAL FIELD

The present invention relates to a fluid drive valve provided with an actuator that opens and closes a fluid passage by introduction and discharge of an operation fluid, respectively, and more particularly to a fluid drive valve that can detect its malfunction.

### BACKGROUND ART

As a sensor that detects malfunction of a fluid drive valve provided with an actuator that opens and closes a fluid passage by introduction and discharge of an operation fluid, respectively, one that detects operation of the actuator is known.

Patent Literature 1 discloses a fluid drive valve (air-operated valve) that can detect malfunction in which an AE sensor is provided.

### CITATION LIST

### Patent Literature

Patent Literature 1: Japanese Unexamined Patent Application Publication JP-A-2010-117330

### SUMMARY OF INVENTION

### Technical Problem

In using the fluid drive valve, it is preferable that leakage of the operation fluid is discovered at an early stage. With a fluid drive valve including a sensor that detects operation of the actuator, in a case where the fluid drive valve is used in an enclosed space such as a cylinder cabinet, for example, when the actuator is able to operate in spite of the occurrence of leakage to some extent, discovery of the leakage ends up being delayed, that is, it is not until the actuator stops operating that malfunction is detected, in some cases. When the actuator stops operating, the valve and the surrounding piping are in a state where the fluid remains therein. In such a state, there is a concern that toxic gases that are not allowed to leak out, such as gases to be used in a semiconductor manufacturing process, for example, fail to be discharged to remain in the valve and the surrounding piping.

The fluid drive valve of Patent Literature 1 requires conducting an inspection for malfunction detection at an appropriate timing, which causes a problem that monitoring all the time cannot be easily continued.

An object of the present invention is to provide a fluid drive valve which facilitates continuation of the monitoring all the time, and which allows detection of the leakage of an operation fluid from an actuator even when the actuator is operating.

### Solution to Problem

The fluid drive valve in accordance with the present invention is a fluid drive valve including: a body provided with a fluid passage; and an actuator configured to open and close the fluid passage by introduction and discharge of an operation fluid, respectively, wherein the fluid drive valve is provided with a pressure sensor on each of a pressure receiving surface, inside the actuator, on which pressure of the operation fluid acts, and a non-pressure receiving surface, inside the actuator, on which pressure of the operation fluid does not act.

The fluid drive valve is a valve that opens and closes a fluid passage by driving a piston utilizing the pressure of an operation fluid. Conventionally, detection of the pressure in such a valve has not been conducted.

In the fluid drive valve of the present invention, the pressure sensor is disposed on each of the pressure receiving surface, inside the actuator, on which the pressure of the operation fluid acts, and the non-pressure receiving surface, inside the actuator, on which the pressure of the operation fluid does not act, whereby monitoring all the time is easily continued, leakage of the operation fluid from the actuator can be detected even when the actuator is operating, and malfunction is discovered at an early stage.

It is preferable that the fluid drive valve further includes: a piston configured to move by introduction and discharge of the operation fluid; a valve stem configured to move a valve element in an opening direction or a closing direction, integrally with the piston; and a casing accommodating the valve stem and the piston, and that the fluid drive valve is further provided with a position sensor configured to detect a position of the valve stem or the piston.

Because the position sensor is additionally provided, whether the actuator is working properly or not is directly detected, whereby the position sensor, together with the pressure sensors disposed on the pressure receiving surface and the non-pressure receiving surface, allows detection of various cases of malfunction, leading to malfunction detection with better accuracy.

Examples of components each forming a pressure receiving surface and a non-pressure receiving surface include a piston, a valve stem, a casing, and the like. The pressure sensor may be disposed on any component. For example, the pressure sensor is disposed on each of a pressure receiving surface of the piston and a non-pressure receiving surface of the piston, in some cases. In addition, the casing consists of a lower casing fixed to the body and an upper casing screwed on the lower casing, and the pressure sensor is disposed on each of a pressure receiving surface and a non-pressure receiving surface of the upper casing, in some cases.

Examples of a component on which the position sensor is disposed include a piston, a valve stem, a casing, and the like. The position sensor may be disposed on any component, but, for example, the position sensor may be disposed on the upper casing to face an upper end portion of the valve stem. This enables the position of the valve stem that opens and closes the valve element to be detected, which is preferable.

The above-described fluid drive valve is preferably combined with a monitoring device including a personal computer, and the like, to constitute a valve monitoring system. In this case, the monitoring device has a communication unit that receives a signal from each of the sensors, a determination unit that determines success or failure on the basis of the signal received from each sensor, and a storage unit that stores the result of the determination made by the determination unit.

### Advantageous Effects of Invention

With the fluid drive valve of the present invention, monitoring all the time is easily continued, leakage of the operation fluid from the actuator is detected even when the actuator is operating, and malfunction is discovered at an early stage.

### BRIEF DESCRIPTION OF DRAWINGS

FIG. 1 is a partially cut away front elevational view of a fluid drive valve in accordance with one embodiment of the present invention.

FIG. 2 shows a valve monitoring system in which the fluid drive valve in accordance with the present invention is used.

FIG. 3 is a partially cut away front elevational view of a fluid drive valve in accordance with another embodiment of the present invention.

FIG. 4 is a graph showing one example of signals obtained from pressure sensors of the fluid drive valve in accordance with the present invention.

FIG. 5 is a graph showing one example of a signal obtained from a position sensor of the fluid drive valve in accordance with the present invention.

### RREFERENCE SIGNS LIST

1: fluid drive valve
2: body
3: actuator
7: casing
8: valve stem
9: piston
11: lower casing
12: upper casing
17: operation fluid introduction chamber
19: non-pressure receiving space
20: sensor device
21: pressure-receiving-surface pressure sensor
22: non-pressure-receiving-surface pressure sensor
23: position sensor

### DESCRIPTION OF EMBODIMENTS

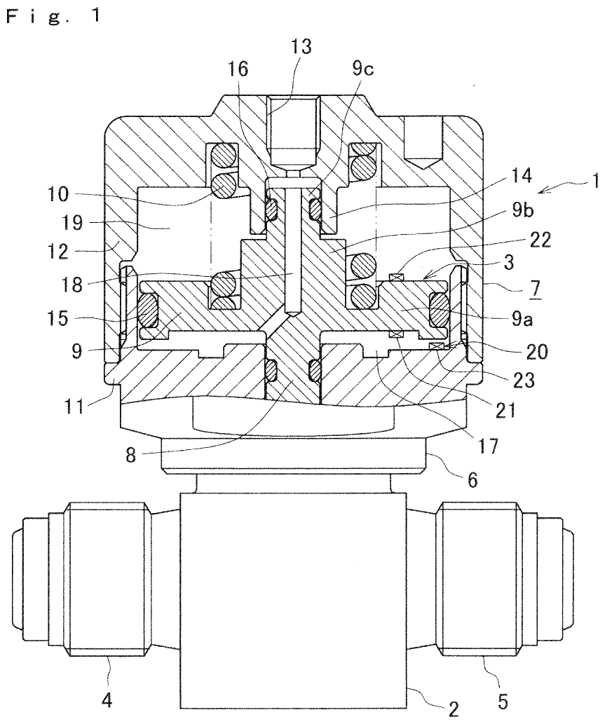

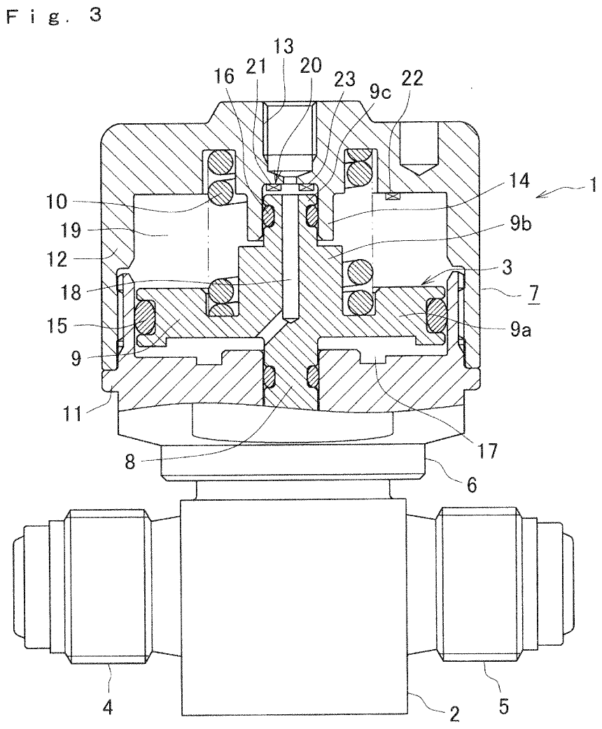

Embodiments of the present invention will be described below with reference to the drawings. In the following description, upper and lower sides and left and right sides of FIG. 1 and FIG. 3 are referred to as the upper and lower sides and the left and right sides, respectively.

The terms, upper and lower sides and left and right sides, are used herein for convenience's sake. The terms, upper and lower sides, may be used in an upside down manner, or may be used to refer to the left and right sides, respectively.

FIG. 1 shows a fluid drive valve in accordance with one embodiment of the present invention. The fluid drive valve 1 includes: a body 2 provided with a fluid passage; an actuator 3 that opens and closes the fluid passage by introduction and discharge of an operation fluid, respectively; and a sensor device 20 that detects malfunction of the fluid drive valve 1.

As for the operation fluid, air is used in many cases, but various types of gases such as N₂, Ar, and the like, may be used.

Inside the body 2, although not shown, a valve element that opens and closes the fluid passage is disposed, and the valve element is moved by operation of the actuator 3 whereby the fluid passage is opened and closed. The body 2 is provided on a left surface thereof with an inlet joint 4 being in communication with a fluid inflow passage. The body 2 is provided on a right surface thereof with an outlet joint 5 being in communication with a fluid outflow passage. Above the body 2, a casing 7 is mounted via a bonnet 6.

The actuator 3 includes: a valve stem 8 that is disposed inside the casing 7 and ascends and descends whereby the valve element is moved in an opening direction and a closing direction; a piston 9 disposed integrally with the valve stem 8; and a compression coil spring (biasing member) 10 that urges the valve stem 8 downward.

The casing 7 consists of: a lower casing 11 fixed to the bonnet 6; and an upper casing 12 screwed on the lower casing 11. The upper casing 12 is provided at a top wall thereof with a female screw portion 13 to which piping for introducing an operation fluid is connected.

The piston 9 consists of: a large diameter portion 9a that moves along the lower casing 11; an intermediate diameter portion 9b that is contiguous with an upper surface of the large diameter portion 9a and has a smaller outside diameter than that of the large diameter portion 9a; and a small diameter portion 9c that is contiguous with an upper surface of the intermediate diameter portion 9b and has a smaller outside diameter than that of the intermediate diameter portions 9b. On the top wall of the upper casing 12, a cylindrical guide portion 14 is formed so as to contiguous with a lower side of the female screw portion 13. The small diameter portion 9c of the piston 9 is fitted into the guide portion 14 so as to move along the guide portion 14. On an outer periphery of the large diameter portion 9a, an annular recess is formed, where an O-ring 15 is disposed to seal between the outer periphery of the large diameter portion 9a and an inner peripheral surface of an peripheral wall of the lower casing 11. In addition, on an outer periphery of the small diameter portion 9c, an annular recess is formed, where an O-ring 16 is disposed to seal between the outer periphery of the small diameter portion 9c and an inner peripheral surface of the guide portion 14.

In the piston 9, an operation fluid passage 18 is formed. The operation fluid passage 18 penetrates a center portion of the small diameter portion 9c and a center portion of the intermediate diameter portion 9b,and is in communication with an operation fluid introduction chamber 17 that is formed between a lower surface of the large diameter portion 9a of the piston 9 and an upper surface of a bottom wall of the lower casing 11.

The compression coil spring 10 is received by: an annular recess that is provided on the upper surface of the large diameter portion 9a of the piston 9; and an annular recess that is provided on a lower surface of the top wall of the upper casing 12. The compression coil spring 10 urges the piston 9 downward whereby the valve stem 8 is moved downward, which causes the fluid passage to be normally in a closed state. When the operation fluid is introduced into the operation fluid introduction chamber 17, the piston 9 and the valve stem 8 are integrally moved upward, whereby an open state of the fluid passage is obtained.

A space between the upper surface of the large diameter portion 9a of the piston 9 and the lower surface of the top wall of the upper casing 12 serves as a non-pressure receiving space 19 that the operation fluid does not enter.

The sensor device 20 has two pressure sensors 21, 22 and one position sensor 23.

The first pressure sensor (hereinafter referred to as “pressure-receiving-surface pressure sensor”) 21 is disposed on the lower surface of the large diameter portion 9a of the piston 9 so as to detect the pressure of the operation fluid introduction chamber 17, that is, a pressure receiving space. The second pressure sensor (hereinafter referred to as “non-pressure-receiving-surface pressure sensor”) 22 is disposed on the upper surface of the large diameter portion 9a of the piston 9 so as to detect the pressure of the non-pressure receiving space 19. The position sensor 23 is disposed on the upper surface of the bottom wall of the lower casing 11 so as to detect the position of the lower surface of the large diameter portion 9a of the piston 9 (distance from the disposed position of the position sensor 23).

When the operation fluid is introduced to cause the actuator 3 to operate, the value of the pressure-receiving-surface surface pressure sensor 21 increases along with a pressure increase inside the operation fluid introduction chamber 17, and the non-pressure-receiving-surface pressure sensor 22 indicates a slight increase in pressure because the non-pressure receiving space 19 is compressed by the piston 9. The value of the position sensor 23 increases because the piston 9 moves upward. During introduction of a constant amount of the operation fluid, each sensor 21, 22, 23 keeps indicating the same value.

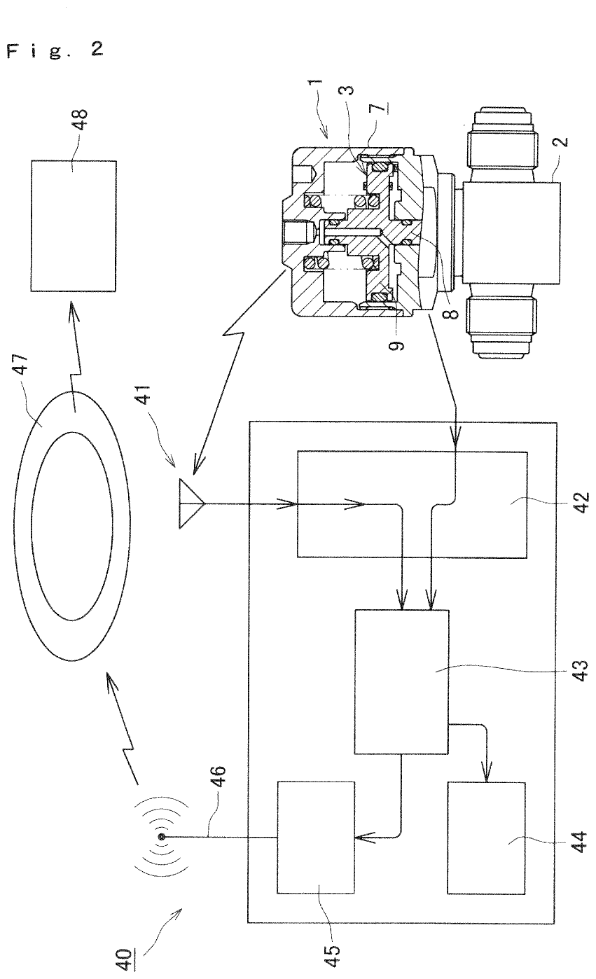

FIG. 2 is a schematic diagram of a monitoring system, in accordance with one embodiment, including: a fluid drive valve 1 having the above-described sensors 21, 22, 23 therein; and a monitoring device 40.

FIG. 2 shows one of many fluid drive valves 1 to be installed in equipment or a plant. In each fluid drive valve 1, an RFID tag, one of electronic tags, in which its own identification number is written, is installed. The RFID tag may be of an active type in which a battery is embedded, or may be of a passive type in which no battery is embedded. In the case where the RFID tag is of the passive type, power is supplied to the RFID tag by radio waves from the monitoring device 40, whereby the RFID tag is powered.

When the identification number of the fluid drive valve 1 is transmitted wirelessly from the RFID tag toward the monitoring device 40, the identification number is received by a reception antenna 41 of a reception unit 42, and then is stored temporarily in a determination unit 43.

Next, signals from the sensors 21, 22, 23 of the fluid drive valve 1 enter the reception unit 42 of the monitoring device 40 via signal lines (no reference signs assigned), to be transmitted to the determination unit 43. Instead of signal transmissions via wired signal lines, a wireless signal transmission method may be utilized.

The determination unit 43 determines whether the signals from the fluid drive valve 1 are a success signal or a failure signal. The determination result and its identification number are paired to be stored in a storage unit 44.

Such paired pieces of information may be displayed on a display unit (not shown) of the monitoring device 40 to be confirmed.

Furthermore, the valve monitoring system is capable of transmitting the paired pieces of information to a transmission unit 45, transmitting the information from a transmission antenna 46 to an Internet network 47 by radio waves, and transmitting the information to a centralized management server 48.

The centralized management server 48 identifies and manages all the valves in the equipment or the plant, and can immediately detect a valve in which malfunction is confirmed and then issue a warning.

Because the sensor device 20 has the pressure-receiving-surface pressure sensor 21, the non-pressure-receiving-surface pressure sensor 22, and the position sensor 23, it is possible to conduct malfunction detection of the fluid drive valve 1 using the signals obtained from these three sensors 21, 22, 23.

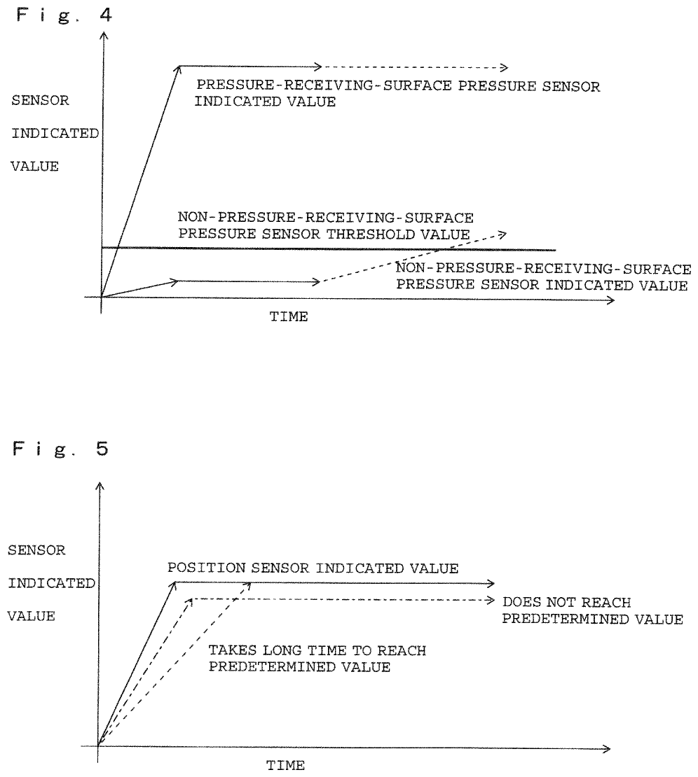

For example, in FIG. 4, in a case where, after the indicated value of the pressure-receiving-surface pressure sensor 21 reaches a predetermined value as indicated by a solid line, the indicated value is maintained as indicated by a broken line following the solid line, but the value of the non-pressure-receiving-surface pressure sensor 22 gradually increases as indicated by a broken line, it is determined that an operation fluid inside the operation fluid introduction chamber 17 flows (leaks) into the non-pressure receiving space 19. Thus, by setting a threshold value with respect to the non-pressure-receiving-surface pressure sensor 22 and by outputting an alarm in the case where the indicated value of the non-pressure-receiving-surface pressure sensor 22 exceeds the threshold value, leakage can be discovered at an early stage and malfunction can be detected before the occurrence of a serious breakdown.

Regarding the position sensor 23, as shown in FIG. 5, there are some cases where it takes long time for the indicated value to reaches a predetermined value, or some cases where the indicated value does not reach the predetermined value. In order to deal with such cases, a threshold value is set, whereby malfunction can be detected before the piston 9 completely stops working.

Furthermore, by detecting what kind of states the signal of the pressure-receiving-surface pressure sensor 21, the signal of the non-pressure-receiving-surface pressure sensor 22, and the signal of the position sensor 23, respectively, indicate, and then making a comprehensive determination, it is possible to grasp the degree of criticalness of malfunction and the degree of urgency to cope with the malfunction, whereby malfunction is discovered at an early stage and the malfunction is coped with at an early stage.

It should be noted that, in FIG. 1, the pressure-receiving-surface pressure sensor 21 that detects the pressure of the operation fluid introduction chamber 17 may be disposed on the upper surface of the bottom wall of the lower casing 11, and the non-pressure-receiving-surface pressure sensor 22 that detects the pressure of the non-pressure receiving space 19 may be disposed on an inner peripheral surface of a peripheral wall of the upper casing 12 or may be disposed on the lower surface of the top wall of the upper casing 12. In addition, the position sensor 23 may be disposed on the lower surface or the upper surface of the large diameter portion 9a of the piston 9, may be disposed on the inner peripheral surface of the peripheral wall of the lower casing 11, or may be disposed on the lower surface of the top wall of the upper casing 12. As described above, each sensor 21, 22, 23 may be disposed at any appropriate position, but one preferred example is shown in FIG. 3.

In FIG. 3, the pressure-receiving-surface pressure sensor 21 and the position sensor 23 are disposed at positions, to face an upper end surface of the valve stem 8, on the lower surface of the top wall of the upper casing 12; and the non-pressure-receiving-surface pressure sensor 22 is disposed at a position, to face the large diameter portion 9a of the piston 9, on the lower surface of the top wall of the upper casing 12. The valve stem 8 is a component to directly open and close the valve element, and therefore, by detecting the position of the valve stem 8 and the pressure acting on the valve stem 8, it is possible to improve the accuracy of malfunction detection. Although the pressure-receiving-surface pressure sensor 21 and the position sensor 23 may also be disposed on the upper end surface of the valve stem 8, if all the sensors 21, 22, 23 are disposed on the upper casing 12, installation of the sensors 21, 22, 23 is facilitated.

In the above-described fluid drive valve 1, the number of piston 9 is one. However, plurality of pistons may be provided therein. The piston 9 may be formed integrally with the valve stem 8, or may be formed separately from the valve stem 8. In accordance with an increase in the number of the piston 9, the number of the operation fluid introduction chamber 17 is increased, and the operation fluid is introduced into each of the operation fluid introduction chambers.

Although the above-described fluid drive valve 1 is of a normally closed type, in which the biasing member 10 urges the valve stem 8 so as to be in a normally closed position, even in the case of the fluid drive valve that is of a normally open type, in which the biasing member urges the valve stem so as to be in a normally open position, malfunction detection at an early stage is an issue to be achieved as in the case of the above-described fluid drive valve 1. Under such circumstances, the above-described sensor device 20 is also applicable to the fluid drive valve of a normally open type.

### INDUSTRIAL APPLICABILITY

With the fluid drive valve in accordance with the present invention, the fluid drive valve including the actuator that opens and closes the fluid passage by introduction and discharge of the operation fluid, respectively, is capable of discovering malfunction at an early stage, and therefore can contribute to safety improvement of an apparatus using the fluid drive valve.

1. A fluid drive valve comprising: a body provided with a fluid passage; and an actuator configured to open and close the fluid passage by introduction and discharge of an operation fluid, respectively,
the fluid drive valve being provided with a pressure sensor on each of a pressure receiving surface, inside the actuator, on which pressure of the operation fluid acts, and a non-pressure receiving surface, inside the actuator, on which pressure of the operation fluid does not act.

2. The fluid drive valve according to claim 1, further comprising: a piston configured to move by introduction and discharge of the operation fluid; a valve stem configured to move a valve element in an opening direction or a closing direction, integrally with the piston; and a casing accommodating the valve stem and the piston, wherein the fluid drive valve is further provided with a position sensor configured to detect a position of the valve stem or the piston.

3. The fluid drive valve according to claim 2, wherein the pressure sensor is disposed on each of a pressure receiving surface of the piston and a non-pressure receiving surface of the piston.

4. The fluid drive valve according to claim 2, wherein the casing consists of a lower casing fixed to the body and an upper casing screwed on the lower casing, and the pressure sensor is disposed on each of a pressure receiving surface and a non-pressure receiving surface of the upper casing.

5. The fluid drive valve according to claim 4, wherein the position sensor is disposed on the upper casing to face an upper end portion of the valve stem.
